(19) United States
(12) Patent Application Publication
(10) Pub. No.: US 2003/0237054 A1
(43) Pub. Date: Dec. 25, 2003

(54) Concept for automated scatter proofing of content elements used in personalized print jobs

(75) Inventor: Timothy F. Donahue, Rochester, NY (US)

Correspondence Address: Lawrence P. Kessler, NexPress Solutions LLC, Patent Department, 1447 St. Paul Street, Rochester, NY, 14653-7103, US

(73) Assignee: NexPress Solutions LLC

(21) Appl. No.: 10/177,784

(22) Filed: Jun. 21, 2002

(51) Int. Cl. G06F 15/00

(52) U.S. Cl. 715/525

(57) ABSTRACT

A method and structure for automatically preparing a scatter proof of a personalized print job that analyzes a personalized print job file to identify recurring content elements, extracts the recurring content elements, and arranges the recurring content elements to generate a scatter proof print image. The method for extracting selects a subset of the recurring content elements to be extracted and arranged on the scatter proof print image. The method further generates meta data associated with the personalized print job that indicates which content elements are the recurring content elements. The meta data is contained within the personalized print job. The method provides user input to determine which of the recurring content elements will be included in the subset. The user input includes information as to data type, object complexity, object predominance, and frequency of object occurrence.

### BACKGROUND OF THE INVENTION

1. Field of the Invention

The present invention relates in general to proof reading personalized print jobs and more particularly, to an approach to a scatter proofing process of the content elements of a personalized print job that automates the content element selection process.

2. Description of the Related Art

It is very difficult to proofread (“proof”) a personalized print job containing a large number of uniquely personalized pages. In order to proofread such a print job, a hard copy simulated color print is generated that is representative of the appearance (look and feel) of all pages of the final published output. This process is very difficult because each page of the job is likely to be unique in layout, and/or visual content, thus making it prohibitive to visually proof each and every page (due to excessive time and cost).

A useful characteristic of personalized print jobs is that there are usually a significant number of content elements which appear identically many times in the pages of such a job. Such content elements are known as recurring content elements. In some cases, recurring content elements make up a relatively high percentage of the content of each page of a personalized print job. Therefore, scatter proofing the recurring content elements, and in some cases the variable content elements, independent of the layout of the pages in which they appear, is a viable approach towards proofing a significant amount of the content of such print jobs.

In conventional printing, scatter proofing is done to verify the color accuracy of color content elements, such as high-resolution color images, that appear on the pages of one or more jobs. In this process, color content elements are often ganged in a multi-up layout and printed on a relatively small number of proof sheets where the color appearance of the printed content elements are known to accurately represent their color appearance as if they were printed on the printing press that will be used to print the final pages. This enables pre-press operators and designers to examine the quality of the color data used in one or more print jobs without having to actually print the complete jobs on the target press.

One conventional method of scatter proofing visual content elements included in static page layouts is a manual process involving a user manually selecting the individual content elements used in the various page layouts, and submitting them to a scatter proofing software application. Some software applications have an input queue that receives the manually selected and submitted content element files. When enough elements to fill a proof sheet are enqueued, the application automatically generates a page layout and forwards it to a color proofing output device such as a four color iris inkjet or Kodak DCP 9000 Dye Sublimation proofer (available from Eastman Kodak Company, Rochester, N.Y., U.S.A). Usually, as many content elements as possible are fit onto a single printed proof sheet in order to minimize the number of proof sheets necessary to produce renditions of all selected content elements.

This method of proofing provides a way to visually inspect all content elements as they would appear when rendered on the final output media, independent of the actual page in which they are normally imposed. The aforementioned hard copy color proofing device (proofer) creates a hard copy print with a look and feel that is known to reliably simulate the appearance of the final printed output. Alternatively, a potentially lower cost option would be to use the actual digital press itself.

The characteristics of personalized print jobs make scatter proofing a more difficult process. In personalized publishing, content elements are either selected from a superset of preexisting content elements (such as recurring content elements), or generated from variable data stored in a recipient record. The content elements included in a personalized print job therefore depend upon the contents of a recipient record such that selection of existing, or the generation of, content elements is a dynamic, data driven process.

Typical variable data print jobs contain a rather large number of documents where each of the documents are usually printed a single time, whereas, a conventional print job usually defines a single document of which many identical copies are printed. The pages of the various documents of a variable data job usually vary in some degree where, for example, some content elements, known as variable content elements, are unique to a single page of all the pages of the job. Other content elements, referred to as recurring content elements, may be reused over and over again in the exact same rendering context among many pages of the job.

In conventional printing, a proof is usually made of every page of the document that simulates the look and feel of the production print. Printing all of the pages of a VDP job as a proof, however, is prohibitive due the large quantity of unique content pages. Therefore, scatter proofing all or the majority of the recurring content elements of a VDP job effectively minimizes the number of proof prints required to adequately proof the appearance of what is likely to be the majority of the content used in the job.

Page description languages such as PPML provide meta-information that explicitly identifies the content elements that are recurring as well as the rendering context, or graphics state, in which they are to be rendered. Since VDP jobs contain such a large number of pages, this explicit identification of recurring elements allows a scanning processor to readily identify them as candidates for inclusion on a multi-up scatter proof.

In situations where recurring content elements of a VDP job are identified and it is determined that the one or more content elements in their respective rendering contexts has already been proofed and approved in previous VDP jobs, then the scatter proofing system can be optimized so that such content elements need not be proofed a second time. Such a proofing system which keeps track of previously scatter proofed content elements could automatically approve content elements already known to have been proofed and approved. This is very useful when more then one personalized job shares recurring content elements.

It is clear that scatter proofing content elements included in personalized print jobs is a more difficult, or perhaps impossible to accomplish if done by traditional manual means. The invention described below addresses this problem using a novel approach to scatter proofing the content elements of a personalized print job that automates the content element selection and scatter proof layout creation process. The invention described below also addresses the problem of minimizing the number of content elements required to be proofed which recur in the same rendering context across more then one variable data print job.

### SUMMARY OF THE INVENTION

In view of the foregoing and other problems, disadvantages, and drawbacks of conventional scatter proofing, the present invention has been devised, and it is an object of the present invention, to provide an improved control for page description language for print files.

The invention includes a method of automatically preparing a scatter proof of a personalized print job. The method analyzes a personalized print job file to identify recurring content elements, extracts the recurring content elements, and arranges the recurring content elements to generate a scatter proof print image. The method for extracting selects a subset of the recurring content elements to be extracted and arranged on the scatter proof print image. The method further generates meta data associated with the personalized print job that indicates which content elements are the recurring content elements. The meta data is contained within the personalized print job. The method provides user input to determine which of the recurring content elements will be included in the subset. The user input includes information as to data type, object complexity, object predominance, and frequency of object occurrence.

Another embodiment comprises a system for automatically preparing a scatter proof of a personalized print job. The system includes an analyzer adapted to identify recurring content elements in a personalized print job file, an extractor adapted to extract the recurring content elements from the personalized print job file, and an arranger adapted to organize the recurring content into a scatter proof print image.

### BRIEF DESCRIPTION OF THE DRAWINGS

The foregoing and other objects, aspects and advantages will be better understood from the following detailed description of a preferred embodiment(s) of the invention with reference to the drawings, in which:

FIG. 1 is a schematic diagram of one embodiment of the invention; and

FIG. 2 is a flowchart illustrating the processing achieved with the invention.

### DETAILED DESCRIPTION OF PREFERRED EMBODIMENTS OF THE INVENTION

As mentioned above, scatter proofing content elements included in personalized print jobs is a more difficult process, or perhaps impossible, if done by traditional manual means. The invention addresses this problem using a novel approach to scatter proofing the content elements of a personalized print job that automates the content element selection process. To do this, the invention provides a mechanism embodied as a software application. The preferred embodiment of this software application processes the final, or intermediate form of the digital print master containing a set of single, or multiple page, personalized documents.

The print master, embodied as one or more PDL coded files, is searched by the application software, and the content elements to be scatter proofed is automatically selected. The selected content elements are automatically identified based on the criteria that the content element data is used more than once on one or more pages of the VDP print job in the exact same rendering context. Copies of the selected content elements are then extracted, along with all recurring rendering contexts, and algorithmically laid out as a proof sheet embodied as a PDL file prepared for printing on a digital proofing device. In some cases, content element data may be rendered more than one time on the proof sheet, in the case where multiple recurring rendering contexts for that content element exist in the VDP job.

Selecting which content elements to scatter proof depends upon the visual complexity of the content element, and the importance of the accuracy of its final color rendition. In most cases where a memory color such as a flesh tone is included in a visual element, it is desirable to visually inspect a hardcopy proof of that element. It would also be desirable to scatter proof only the subset of the set of existing content elements that are included in the particular personalized print job, and exclude those that are not. The selection of which content elements from among the superset of content elements to scatter proof is therefore a data driven selection process, and can easily be automated by a software process. In the case of variable content elements, such as a digital color portrait image of a particular recipient pulled from a database, or data generated graphical elements such as bar, pie charts, or geographical maps, it may also be desirable to scatter proof all, or a subset of such elements.

The invention provides an automatic process that performs the steps of analyzing the PDL job file(s) and identifying all recurring content elements, selecting all or a subset of the identified recurring content elements, extracting all of the selected content elements, and generating a single or multi-page print job that contains all of the extracted recurring content elements.

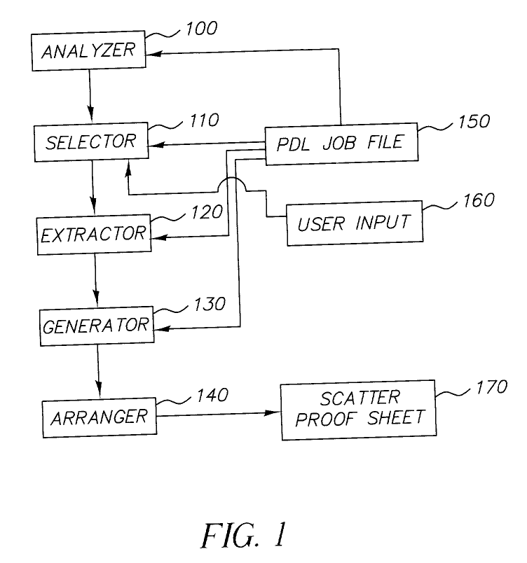

More specifically, as shown in the schematic diagram in FIG. 1, an analyzer 100 analyzes the PDL job file 150 to identify all recurring content elements. A selector 110 selects all, or a subset, of the recurring content elements based, at least in part, upon user input 160. The extractor 120 extracts the selected recurring content elements from the PDL job file 150, and a generator 130 generates a single or multi-page print job. The arranger 140 arranges the recurring content elements to most efficiently utilize the scatter proof sheet 170.

The layout may either be determined automatically by a best fit arrangement of the page elements that economizes on the use of the output media, or by a user supplied template that specifies a particular layout arrangement. Each rendition of a recurring content element on the proof sheet is identified by a text caption which may, for example, include the name of the PDL source file and/or the identifier name by which the particular rendition of the recurring object is referred to in the print master file. The method of best fit arrangement of the renditions of the content elements on the proof sheet is well-known in conventional scatter proofing of non-variable print jobs. In some cases where only color accuracy is important, the renditions of the content elements may be resized so as to allow for more content elements to be arranged on the proof sheet and thus conserve proof media.

An important feature of the invention is the automatic selection of content elements based on their usage in a PDL coded print job file. The selection criteria for determining which content elements to scatter proof may be supplied by the user of the software application through selection filter options. The options allow the user to specify which content elements to scatter proof based on such attributes as data type (sampled image, vector graphics, text), object complexity (size of an image), color space encoding (CMYK, RGB, L*a*b*), predominance on a page, and frequency of occurrence threshold, among others.

The invention identifies content elements though the use of meta data that is stored within, or associated with the PDL job file or files. The software merge application that created the personalized PDL job files(s) is used by the invention to generate the meta data. The meta data is either embedded within the PDL job file, or stored in a separate file external to the PDL job file. The merge engine executes page composition rules driven by data stored in the records of a recipient database. Each record executed typically generates a single instance document and the associated page content. As the merge engine encounters selection of content elements, it recognizes when content elements are reused in the same rendering context and keeps track of their reuse. After all records are executed, the merge engine then writes out the PDL in such a way that the recurring content objects are explicitly identified. The designer normally has no manual control of this, other than how they define the data driven content selection and formatting rules.

In the preferred embodiment, the scatter proof sheet(s) that are automatically generated are optionally tagged with caption text that identifies the origin of the content element, as well as which personalized document and page (or pages) of the personalized document (or documents) in which the element appears. The information used for generation of the caption text may also be included as meta data in the PDL files.

The generated scatter proof job is then printed on either a hard copy proofing device that simulates the appearance of what the page elements would look like when printed on the final printer, as in the case of the final printer being the target digital color printer or press.

The invention provides a personalized PDL print job file that contains meta data that assists in the searching and identification of content elements. Such content elements are extracted and included in a new PDL instance, which defines the content for the scatter proof sheet. The meta data contains information that explicitly indicates the content element is recurring, including the element's content data type, frequency of usage, and the origin (e.g., first use) of the content elements.

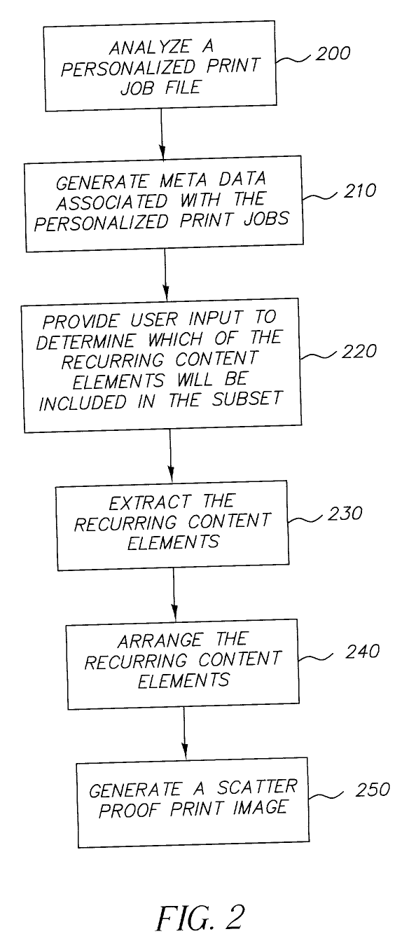

FIG. 2 is a flowchart illustrating the process of the invention which analyzes a personalized print job file 200, generates meta data associated with the personalized print jobs 210, provides user input to determine which of the recurring content elements will be included in the subset 220, extracts the recurring content elements 230, arranges the recurring content elements 240, and generates a scatter proof print image 250.

The invention provides a method of soft proofing or hard copy proofing PDL coded print jobs, and in particular, personalized PDL coded print jobs by applying statistical and structural hint information available within or external to the PDL coded print job. This assists a software process in the selection of candidate recurring content elements. This method automatically identifies and extracts PDL coded content elements and automatically composes, or lays out, these elements on a page for the purpose of hard copy scatter proofing. The type of PDL coded jobs that benefit from this approach to scatter proofing are jobs of the kind that contain a significant amount of recurring content, such as personalized print jobs.

Meta data, or hint information about the PDL coded print job in the form of statistical information, is stored within the PDL coded print file (or external to the PDL coded print file) and is used as hint information to obviate the PDL coded print file's usage of the visual content elements.

Another variation of this invention is to extend its functionality to minimize the required amount of content element proofing when proofing a set of variable data jobs which use a common set of recurring content elements. The method involves tracking recurring content elements used across multiple variable data print jobs where the recurring content elements are identified to a tracking system.

In the preferred embodiment, the recurring elements are uniquely identified to the tracking system by an identifier which is derived from the name of the PDL source data file which defines the content definition (e.g., EPS, or PDF data file), a unique identifier of the data file derived from some metric such as a checksum of that data file derived by the MD5 checksum algorithm, and the rendering context under which that content element was proofed. A record of information is then stored in the tracking system for each proofed content element which is identified and accessed by this unique identifier. Such a record contains status information that indicates whether a rendition of the content element it describes had been previously proofed and whether or not it was determined to be acceptable. Additional information such as the substrate types on which it was previously proofed, as well as which halftone screen, was used in the proof rendition, among other attributes which contribute to its subjective appearance, may also be stored.

A scatter proof of a first VDP job is performed using the method of scatter proofing of this invention. The software application which automatically selects the recurring content elements of the job to be ganged onto one or more proof sheets creates a new record for each recurring content element and adds it to the tracking system under a unique identifier, as described above. Once the scatter proof is printed and the proofreader examines each rendered content element, the status of whether or not it is acceptable is recorded in the record in the tracking system that corresponds to it. Typically, those content elements that are rejected are revised by the page designer and either included in a newly generated version of the VDP job, or simply used as replacements for the respective rejected content elements of the previous job.

When a second VDP job which shares equivalent renditions of some of the same content element data used in the first job is proofed, the tracking system is used by the automatic recurring content element selection software to determine which of the recurring content elements have already been approved, where already approved content elements are automatically not included in the scatter proofs. The benefit of this is to further streamline the content proofing process for variable data jobs, which tend to be run on a routine basis (e.g., monthly basis) with revised variable content and commonly reused recurring content elements. It in effect reduces the number of times recurring content elements need to be proofed for a suite of variable data print jobs by utilizing a common set of recurring content elements. Ideally, recurring content elements common to many jobs will only need to be proofed a single time.

The invention provides an automatic process that performs the steps of analyzing the PDL job file(s) and identifying all recurring content elements, selecting all or a subset of the identified recurring content elements, extracting all of the selected content elements, and generating a single or multi-page print job that contains all of the extracted recurring content elements.

The invention includes a method of automatically preparing a scatter proof of a personalized print job. The method analyzes a personalized print job file to identify recurring content elements, extracts the recurring content elements, and arranges the recurring content elements to generate a scatter proof print image. The method for extracting selects a subset of the recurring content elements to be extracted and arranged on the scatter proof print image. The method further generates meta data associated with the personalized print job that indicates which content elements are the recurring content elements. The meta data is within the personalized print job. The method provides user input to determine which of the recurring content elements will be included in the subset. The user input includes information as to data type, object complexity, object predominance, and frequency of object occurrence.

### PARTS LIST

100 Analyzer

110 Selector

120 Extractor

130 Generator

140 Arranger

150 PDL Job File

160 User Input

170 Scatter Proof Sheet

200 Personalized Print Job File

210 Personalized Print Job

220 Subset

230 Extracted Content Elements

240 Arranged Content Elements

250 Print Image

What is claimed is:

1. A method of automatically preparing a scatter proof of a personalized print job, said method comprising:
analyzing a personalized print job file to identify recurring content elements;
extracting said recurring content elements; and
arranging said recurring content elements to generate a scatter proof print image.

2. The method in claim 1, wherein said extracting further comprises selecting a subset of said recurring content elements to be extracted and arranged on said scatter proof print image.

3. The method in claim 1, further comprising generating meta data associated with said personalized print job that indicates which content elements are said recurring content elements.

4. The method in claim 3, wherein said meta data is within said personalized print job.

5. The method in claim 2, further comprising providing user input to determine which of said recurring content elements will be included in said subset.

6. The method in claim 5, wherein said user input includes information as to at least one of data type, object complexity, object predominance, and frequency of object occurrence.

7. The method of claim 1, further comprising after said extracting process, a process of removing previously proofed content elements from said recurring content elements.

8. A system for automatically preparing a scatter proof of a personalized print job comprising:
an analyzer adapted to identify recurring content elements in a personalized print job file;
an extractor adapted to extract said recurring content elements from said personalized print job file; and
an arranger adapted to organize said recurring content into a scatter proof print image.

9. The system in claim 8, wherein said extractor selects a subset of said recurring content elements to be extracted and arranged on said scatter proof print image.

10. The system in claim 8, further comprising a generator adapted to accumulate meta data associated with said personalized print job, wherein said meta data indicates which content elements are said recurring content elements.

11. The system in claim 10, wherein said meta data is stored within personalized print job.

12. The system in claim 9, further comprising a user interface adapted to accept user input to determine which of said recurring content elements will be included in said subset.

13. The system in claim 12, wherein said user input includes information as to at least one of data type, object complexity, object predominance, and frequency of object occurrence.

14. A method of automatically preparing a scatter proof of a personalized print job, said method comprising:
analyzing a personalized print job file to identify recurring content elements;
extracting said recurring content elements;
removing previously proofed content elements from said recurring content elements; and
arranging said recurring content elements to generate a scatter proof print image.

15. The method in claim 14, wherein said extracting further comprises selecting a subset of said recurring content elements to be extracted and arranged on said scatter proof print image.

16. The method in claim 14, further comprising generating meta data associated with said personalized print job that indicates which content elements are said recurring content elements.

17. The method in claim 14, wherein said meta data is stored within said personalized print job.

18. The method in claim 15, further comprising providing user input to determine which of said recurring content elements will be included in said subset.

19. The method in claim 18, wherein said user input includes information as to at least one of data type, object complexity, object predominance, and frequency of object occurrence.
